(19) United States
(12) Patent Application Publication
(10) Pub. No.: US 2017/0310736 A1
(43) Pub. Date: Oct. 26, 2017

(54) METHOD AND SYSTEM FOR SHARING FILE BETWEEN MOBILE TERMINALS

(71) Applicant: JRD Communication Inc., Shenzhen (CN)

(72) Inventors: Weiqin YANG, Shenzhen (CN); Bin YU, Shenzhen (CN)

(73) Assignee: JRD Communication Inc., Shenzhen (CN)

(21) Appl. No.: 15/323,962

(22) PCT Filed: May 18, 2016
(86) PCT No.: PCT/CN2016/082530

§ 371 Date: Jan. 4, 2017

(30) Foreign Application Priority Data
Sep. 23, 2015 (CN) 201510609902.X

(51) Int. Cl. H04L 29/08; H04W 8/18; H04W 76/02; H04W 76/06; H04W 4/06; H04W 84/18; H04W 84/12

(52) U.S. Cl. CPC H04L 67/06; H04W 76/06; H04W 8/18; H04W 4/06; H04W 76/023; H04W 84/12; H04W 84/18

(57) ABSTRACT

A method and system for sharing a file between mobile terminals is provided. When a first mobile terminal detects an operation of sharing a file with a second mobile terminal, the first mobile terminal establishes a connection with the second mobile terminal by broadcasting an SSID sequence, and transmits a file that needs to be shared to the second mobile terminal. Accordingly, the first mobile terminal can directly share a file with the second mobile terminal by only one operation step, which brings convenience to a user.

### TECHNICAL FIELD

The present disclosure relates to the field of mobile terminal technologies, and in particular, to a method and system for sharing a file between mobile terminals.

### BACKGROUND

During daily use of mobile terminals such as mobile phones, users generally need to share a file between them, for example, to share files such as a picture and a video. In the prior art, the process of sharing between users is generally complicated, for example, if a user A intends to share a file with a user B, multiple steps need to be performed.

Step 1: The user A is connected to the user B in a wireless manner.

Step 2: The user A selects a file that needs to be shared and sends the file to the user B.

Step 3: The user B receives the file shared by the user A.

The step 1 further includes the following steps:

Step 1.1: The user A (or B) finds wireless information of the user B (or A) through searching.

Step 1.2: The user A (or B) sends a request for establishing a wireless connection to the user B (or A).

Step 1.3: The user B (or A) receives the request for establishing a wireless connection sent by the user A (or B).

Step 1.4: The user B (or A) feeds back an agreement on a wireless connection to the user A (or B).

Step 1.5: The establishment of the wireless connection between the user A (or B) and the user B (or A) is finished.

In view of the above, during an actual application, the user A and the user B generally need multiple operations on mobile terminals to share a file, and the process is rather complicated and inconvenient.

Therefore, the prior art still has room for improvement.

### SUMMARY

A method and system for sharing a file between mobile terminals is provided, which can solve the problem of a complicated and inconvenient process for sharing a file between mobile terminals in the prior art, in which multiple operations are required on the mobile terminals.

In an embodiment, a method for sharing a file between mobile terminals is provided, which may include:

acquiring an SSID sequence corresponding to a second mobile terminal when a first mobile terminal detects an operation of sharing the file with the second mobile terminal;

comparing a size of the file with a set threshold; and when the size of the file exceeds the threshold, storing the file in an intermediate memory space and generating a download link;

broadcasting, by the first mobile terminal, the SSID sequence and establishing a connection with the second mobile terminal;

transmitting, by the first mobile terminal, the download link to the second mobile terminal; and

transmitting, by the first mobile terminal, the file that needs to be shared to the second mobile terminal, when the file size is less than or equal to the threshold.

In a further embodiment, the intermediate memory space comprises a cloud server.

In yet a further embodiment, before acquiring the SSID sequence the method may further include:

enabling WI-FI functions of the first mobile terminal and the second mobile terminal in advance.

In yet a further embodiment, the acquiring may include:

acquiring the file that needs to be shared when the first mobile terminal detects the operation of sharing the file with the second mobile terminal;

comparing the second mobile terminal with a pre-established mobile terminal database; and

acquiring an SSID sequence corresponding to the second mobile terminal according to a comparison result.

In yet a further embodiment, the mobile terminal database is pre-disposed in the first mobile terminal, and the mobile terminal database comprises a mobile terminal establishing a connection with the first mobile terminal through an SSID sequence and a corresponding SSID sequence.

In yet a further embodiment, the method may further include:

generating, by the first mobile terminal, the SSID sequence randomly when the second mobile terminal does not exist in the pre-established mobile terminal database, and sending the SSID sequence to the second mobile terminal;

receiving, by the second mobile terminal, the SSID sequence and storing it; and

binding, by the first mobile terminal, the second mobile terminal and the SSID sequence and storing them in the mobile terminal database.

In yet a further embodiment, the broadcasting may include:

broadcasting, by the first mobile terminal, the SSID sequence circularly, a time interval thereof being T1;

sending, by the second mobile terminal, a connection request to the first mobile terminal when the SSID sequence is found through searching; and stopping the broadcasting, by the first mobile terminal, of the SSID sequence and establishing a connection with the second mobile terminal.

In yet a further embodiment, the sending may include:

comparing, by the second mobile terminal, the SSID sequence with an SSID sequence stored in the second mobile terminal when the SSID sequence is found through searching; and

sending, by the second mobile terminal, the connection request to the first mobile terminal when the SSID sequence found through searching is identical to the SSID sequence stored by the second mobile terminal.

In yet a further embodiment, after the transmitting the method may further include: disconnecting the connection with the second mobile terminal after the first mobile terminal finishes transmitting the file.

In an embodiment, a method for sharing a file between mobile terminals is provided, which may include: acquiring an SSID sequence corresponding to a second mobile terminal when a first mobile terminal detects an operation of sharing the file with the second mobile terminal;

broadcasting, by the first mobile terminal, the SSID sequence and establishing a connection with the second mobile terminal; and

transmitting, by the first mobile terminal, the file to the second mobile terminal.

In a further embodiment, before the acquiring an SSID sequence corresponding to a second mobile terminal when a first mobile terminal detects an operation of sharing a file with the second mobile terminal, the method may further include:

enabling WI-FI functions of the first mobile terminal and the second mobile terminal in advance.

In yet a further embodiment, the acquiring may include:

acquiring the file that needs to be shared when the first mobile terminal detects the operation of sharing the file with the second mobile terminal;

comparing the second mobile terminal with a pre-established mobile terminal database; and

acquiring an SSID sequence corresponding to the second mobile terminal according to a comparison result.

In yet a further embodiment, the mobile terminal database is pre-disposed in the first mobile terminal, and the mobile terminal database comprises a mobile terminal establishing a connection with the first mobile terminal through an SSID sequence and a corresponding SSID sequence.

In yet a further embodiment, the method for sharing a file between mobile terminals may further include: generating, by the first mobile terminal, the SSID sequence randomly when the second mobile terminal does not exist in the pre-established mobile terminal database, and sending the SSID sequence to the second mobile terminal;

receiving, by the second mobile terminal, the SSID sequence and storing it; and

binding, by the first mobile terminal, the second mobile terminal and the SSID sequence and storing them in the mobile terminal database.

In yet a further embodiment, the broadcasting may include:

broadcasting, by the first mobile terminal, the SSID sequence circularly, a time interval thereof being T1;

sending, by the second mobile terminal, a connection request to the first mobile terminal when the SSID sequence is found through searching; and

stopping the broadcasting, by the first mobile terminal, of the SSID sequence and establishing a connection with the second mobile terminal.

In yet a further embodiment, the sending may include:

comparing, by the second mobile terminal, the SSID sequence with an SSID sequence stored in the second mobile terminal when the SSID sequence is found through searching; and

sending, by the second mobile terminal, the connection request to the first mobile terminal when the SSID sequence found through searching is identical to the SSID sequence stored by the second mobile terminal.

In yet a further embodiment, the method may further include, after the transmitting:

disconnecting the connection with the second mobile terminal after the first mobile terminal finishes transmitting the file.

In an embodiment, a system for sharing a file between mobile terminals is described which may include: a first mobile terminal and a second mobile terminal, wherein

the first mobile terminal comprises one or more modules configured to:
broadcast a SSID sequence circularly at a time interval T1;
confirm a connection request sent to the first mobile terminal, and establish a connection with the second mobile terminal sending the request;
send the file to the connected second mobile terminal;

and wherein the second mobile terminal comprises one or more modules configured to:
search for the SSID sequence stored in the second mobile terminal;
send a connection request to the first mobile terminal broadcasting the SSID sequence; and
receive the file sent by the connected first mobile terminal.

In a further embodiment, the one or more modules of the first mobile terminal may further be configured to:

store a database comprising a mobile terminal establishing a connection with the first mobile terminal through an SSID sequence and a corresponding SSID sequence.

In yet a further embodiment, the one or more modules of the first mobile terminal may be further configured to:

disconnect the connection with the second mobile terminal after the first mobile terminal finishes sending the file.

Thus, a method and system for sharing a file between mobile terminals is provided. When a first mobile terminal detects an operation of sharing a file with a second mobile terminal, an SSID sequence corresponding to the second mobile terminal is acquired; the first mobile terminal establishes a connection with the second mobile terminal through broadcasting the SSID sequence, and the first mobile terminal transmits the file that needs to be shared to the second mobile terminal. When the first mobile terminal needs to share a file with the second mobile terminal, the first mobile terminal can directly share the file with the second mobile terminal by only one operation step, which greatly improves the operation efficiency of the mobile terminal, and brings convenience to a user. It fundamentally solves the problem of a complicated and inconvenient process for sharing a file between mobile terminals in the prior art, in which multiple operations are required on the mobile terminals.

### BRIEF DESCRIPTION OF THE DRAWINGS

FIG. 1 depicts a flow chart of a method for sharing a file between mobile terminals, according to a preferred exemplary embodiment of the present invention;

FIG. 2 depicts a flow chart of a method for sharing a file between mobile terminals, according to a preferred exemplary embodiment of the present invention; and

FIG. 3 depicts a schematic structural diagram of a system for sharing a file between mobile terminals, according to a preferred exemplary embodiment of the present invention.

### DETAILED DESCRIPTION

The present invention provides a method and system for sharing a file between mobile terminals. In order that the objectives, technical solutions and effects of the present invention become clearer, the present invention is further described in detail through the accompanying drawings and embodiments. It should be understood that the specific embodiments described herein are merely used to explain the present invention, and are not intended to limit the present invention.

Content of the present invention is further illustrated through the descriptions on the embodiments with reference to the accompanying drawings.

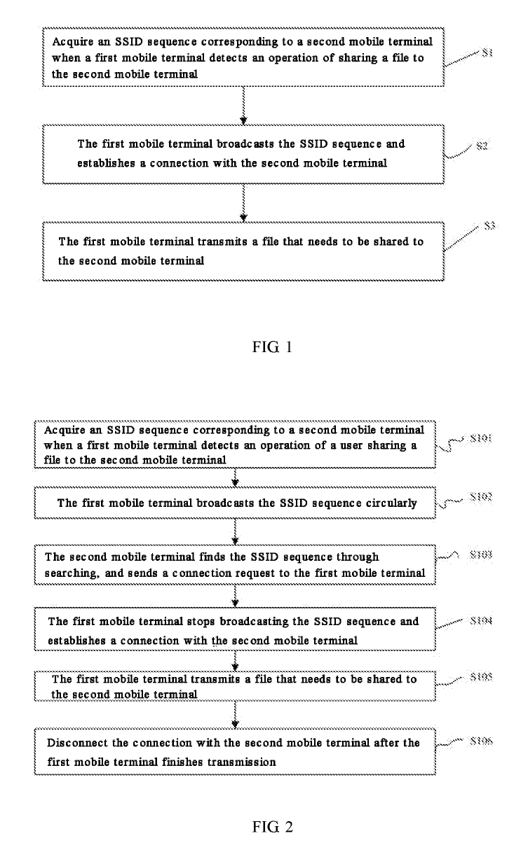

Referring to FIG. 1, FIG. 1 is a flow chart of a preferred embodiment of a method for sharing a file between mobile terminals provided in the present invention. The method may include the following:

An SSID sequence corresponding to a second mobile terminal is acquired when a first mobile terminal detects an operation of sharing a file with the second mobile terminal. (Block S1)

In this embodiment, the first mobile terminal and the second mobile terminal are both smart terminals having wireless functions, and may be mobile phones, PADs, notebook computers, or the like. Before block S1, the first mobile terminal and the second mobile terminal may enable wireless functions; in other words, the first mobile terminal and the second mobile terminal are connected in a wireless manner.

Further, the SSID sequence is an abbreviation of a Service Set Identifier, which indicates a service set identifier and is generally broadcast through an AP (Access Point). The SSID sequence is a name of a local area network, and setting the same SSID value enables mutual communication between devices. Here, the SSID sequence is formed by several SSIDs. To facilitate description, an array is used for expression as follows:

SSIDXL[0], SSIDXL[1], SSIDXL[N−1], N being the number of SSIDs, a common SSIDXL[0], a common SSIDXL[1], a common SSIDXL[2], . . . , a common SSIDXL[N−2], a common SSIDXL[N−1], wherein N represents the number of SSIDs. The selection of the corresponding SSID sequence may be input by a user, and may also be randomly generated by the first mobile terminal. Here, it is not specifically limited, and only examples are provided for illustration. For example, the SSID sequence is “yyu,” “y6yu,” “ayyu,” “qwcc” and “g5yyu6.” In other words, the number of the SSID sequences N=4, SSIDXL[0]=“yyu,” SSIDXL[1]=“y6yu,” SSIDXL[2]=“ayyu,” and SSIDXL[3]=“g5yyu6.”

Specifically, the specific process of acquiring an SSID sequence corresponding to a second mobile terminal when a first mobile terminal detects an operation of sharing a file with the second mobile terminal may be as follows:

The file that needs to be shared is acquired when the first mobile terminal detects the operation of sharing the file with the second mobile terminal. (Block S11)

Specifically, the file that needs to be shared may be a picture, music, a video or the like. A corresponding shared file is acquired when the first mobile terminal monitors an operation instruction of sharing the file of the user.

The second mobile terminal is compared with a pre-established mobile terminal database. (Block S12)

Specifically, the mobile terminal database is pre-disposed in the first mobile terminal, and includes a mobile terminal establishing a connection with the first mobile terminal through an SSID sequence and a corresponding SSID sequence. In an actual application, the mobile terminal database may be preset by the user. The user stores a mobile terminal that may share a file and a corresponding SSID sequence thereof in the first mobile terminal as a group of information, the SSID sequence is sent to the corresponding mobile terminal, and the mobile terminal is notified to store the SSID sequence for the file sharing operation. In this way, the first mobile terminal first presets a mobile terminal database, and when the user shares a file, the first mobile terminal may directly establish a connection with a mobile terminal receiving the shared file, which simplifies the operation steps of sharing the file and brings convenience for the user. The mobile terminal database may further be obtained by accumulation when the first mobile terminal performs file sharing with the receiving terminal. In other words, the first mobile terminal is assigned with a string of SSID sequence when being connected with another mobile terminal, and at the same time, the first mobile terminal may send this string of SSID sequence to the mobile terminal connected thereto, and notify the mobile terminal to store the SSID sequence for the file sharing operation. Therefore, for each mobile terminal that has been connected to the first mobile terminal, the first mobile terminal may store a string of unique SSID sequence. When it is needed to share a file with a mobile terminal once again, the first mobile terminal searches the mobile terminal database for the SSID sequence corresponding to the mobile terminal.

Further, the first mobile terminal binds the mobile terminal and the corresponding SSID sequence into a group of information and stores the group of information in the mobile terminal database. In other words, when the information of the mobile terminal is known, the SSID sequence corresponding to the mobile terminal may be acquired. When the SSID sequence is known, the mobile terminal corresponding to the SSID sequence may be acquired. Here, the mobile terminal establishing a connection with the first mobile terminal through the SSID sequence refers to a mobile terminal that has performed the file sharing operation with the first mobile terminal, and a connection is established after SSID sequence verification is passed. The mobile terminal database may store a name of the mobile terminal establishing a connection with the first mobile terminal through an SSID sequence and the corresponding SSID sequence thereof, and may also store a personalized label, that is set for the mobile terminal and can uniquely identify the mobile terminal, such as a user name, a nickname, a head portrait, a signature or the like, and a corresponding SSID sequence thereof. In this way, when the first mobile terminal acquires the mobile terminal that needs to share a file, the mobile terminal database may be searched for the personalized label corresponding to the mobile terminal, to acquire the mobile terminal and the corresponding SSID sequence.

Further, in the mobile terminal and the corresponding SSID sequence stored in the mobile terminal database, SSID sequences corresponding to the different mobile terminals are different. In other words, each mobile terminal corresponds to a unique SSID sequence.

An SSID sequence corresponding to the second mobile terminal is acquired according to a comparison result. (Block S13)

Specifically, if the first mobile terminal finds the second mobile terminal in the mobile terminal database, an SSID sequence corresponding to the second mobile terminal is acquired. If the first mobile terminal does not find the second mobile terminal in the mobile terminal database, the first mobile terminal generates an SSID sequence randomly, and sends the SSID sequence to the second mobile terminal. The second mobile terminal receives the SSID sequence and stores it. The first mobile terminal binds the SSID sequence corresponding to the second mobile terminal and a personalized identifier uniquely identifying the second mobile terminal into a group of information, and stores the information in the mobile terminal database.

The first mobile terminal broadcasts the SSID sequence and establishes a connection with the second mobile terminal. (Block S2)

In this embodiment, the first mobile terminal plays the SSID sequence circularly. Here, illustration is made by using expressing the SSID provided in the foregoing by an array as an example. For example, the number of the SSID sequences N=4, SSIDXL[0]=“yyu,” SSIDXL[1]=“y6yu,” SSIDXL[2]=“ayyu,” and SSIDXL[3]=“g5yyu6.” The first mobile terminal first broadcasts SSIDXL[0]=“yyu,” and broadcasts SSIDXL[1]=“y6yu” after finishing broadcasting SSIDXL[0], and so on, until SSIDXL[3]=“g5yyu6” is broadcast, the SSID sequence is broadcast once. After SSIDXL[3] is broadcast, the SSID sequence is broadcast repeatedly, and in other words, the sequence is broadcast from the beginning, that is, SSIDXL[0] is broadcast after the broadcasting of SSIDXL[3] is finished. Here, a time interval of broadcasting the SSID sequence is T1, and a time interval of broadcasting each SSID in the SSID sequence is also T1. Here, T1 may be 1 second, 1.5 seconds, 2 seconds, 3 seconds or the like, which is not specifically limited herein, and merely a preferred option of 2 seconds is provided. In this way, the continuity of the broadcasting of the SSID sequence may be ensured, and also the receiving mobile terminal may determine each SSID and the SSID sequence, thereby establishing a connection more quickly and accurately.

In an actual application, the specific process of broadcasting, by the first mobile terminal, the SSID sequence and establishing a connection with the second mobile terminal may be:

The first mobile terminal broadcasts the SSID sequence circularly. (Block S21)

Specifically, the first mobile terminal broadcasts the SSID sequence circularly. A time interval of broadcasting the SSID each time is T1. In other words, after the first broadcast ends, it starts to broadcast the SSID sequence for the second time after a time interval of T1. Here, the time interval of broadcasting each SSID in the SSID sequence may also be T1. In this way, the continuity of broadcasting the SSID sequence circularly may be ensured.

The second mobile terminal sends a connection request to the first mobile terminal when the SSID sequence is found through searching. (Block S22)

Specifically, after the second mobile terminal finds the SSID sequence through searching, a verification process may be included, in which it is verified whether the SSID sequence found through searching is consistent with the SSID sequence stored for sharing a file with the first mobile terminal. The second mobile terminal sends a connection request to the first mobile terminal if the SSID sequence found through searching is consistent with the SSID sequence stored by the second mobile terminal and used for sharing a file with the first mobile terminal. The first mobile terminal is notified that the SSID sequence does not exists and a connection cannot be established, if the SSID sequence found through searching is inconsistent with the SSID sequence stored by the second mobile terminal and used for sharing a file with the first mobile terminal. Here, the second mobile terminal may notify, in a conventional manner, the first mobile terminal that a connection cannot be established, and may notify the first mobile terminal in a communication manner such as a short message, WeChat, QQ and the like.

The first mobile terminal stops broadcasting the SSID sequence and establishes a connection with the second mobile terminal. (Block S23)

Specifically, after the first mobile terminal receives a request for establishing a connection from the second mobile terminal, the first mobile terminal stops broadcasting the SSID sequence and establishes a connection with the second mobile terminal.

Further, if the first mobile terminal receives a notification of being unable to establish a connection sent by the second mobile terminal, the first mobile terminal stops broadcasting the SSID sequence, sends the stored SSID sequence of the second mobile terminal to the second mobile terminal, and notifies the second mobile terminal to store the SSID sequence; therefore, the SSID sequence may be used for file sharing subsequently. The SSID sequence is then broadcast. If the first mobile terminal does not receive the request for establishing a connection and the notification of being unable to establish a connection sent by the second mobile terminal, the first mobile terminal stops broadcasting the SSID sequence, detects an SSID sequence corresponding to the second mobile terminal again, and broadcasts again. Here, the period of time may be 1 minute, 1.5 minutes, or 2 minutes, which is not limited specifically, and can be determined according to the condition of the SSID sequence.

Further, when the request for establishing a connection and the notification of being unable to establish a connection are not received from the second mobile terminal when the SSID sequence is repeated multiple times for the first time, an SSID sequence may be generated randomly for the second mobile terminal, the SSID sequence is sent to the second mobile terminal, and is used to update the SSID sequence corresponding to the second mobile terminal in the mobile terminal database. The newly generated SSID sequence is broadcast again, and a connection is established.

The first mobile terminal transmits the file that needs to be shared to the second mobile terminal. (Block S3)

Specifically, the connection with the second mobile terminal is disconnected after the first mobile terminal finishes file sharing. Before the first mobile terminal transmits the file that needs to be shared to the second mobile terminal, the first mobile terminal may compare the size of the file that needs to be shared with a set threshold. When the size of the file exceeds the threshold, the user may store the file in an intermediate memory space such as a cloud server in advance, and generate a download link. After the first mobile terminal establishes a connection with the second mobile terminal, the download link is transmitted to the second mobile terminal. The first mobile terminal may transmit the file that needs to be shared to the second mobile terminal directly in a wireless manner, when the file size is less than or equal to the threshold.

Further, the threshold may be set according to different requirements of the user, and here, illustration is made by using the threshold of the file size being 20M as an example. When the user intends to share a file, the user selects a file that needs to be shared, detects the size of the file, determines, according to the size of the file, whether it is needed to store the file in an intermediate memory in advance, and generates a download link. In other words, this method can not only transmit the shared file, but also transmit a download link of the shared file. Therefore, after the user selects the file that needs to be shared, the first mobile terminal first determines the size of the transmitted file, and if the file size is greater than 20M, it indicates that the file needs to be uploaded to the intermediate memory first and a download link is generated, and the first mobile terminal shares the download link of the file to the second mobile terminal. If the file size is less than or equal to 20M, it indicates that the first mobile terminal can directly share the file with the second mobile terminal, and then, this method does not include the step of uploading the file to the intermediate memory.

To further understand the method for sharing a file between mobile terminals, a specific embodiment is provided here for further illustration, referring to FIG. 2. The method may include:

An SSID sequence corresponding to a second mobile terminal is acquired when a first mobile terminal detects an operation of a user sharing a file with the second mobile terminal. (Block S101)

The first mobile terminal broadcasts the SSID sequence circularly. (Block S102)

The second mobile terminal finds the SSID sequence through searching, and sends a connection request to the first mobile terminal. (Block S103)

The first mobile terminal stops broadcasting the SSID sequence and establishes a connection with the second mobile terminal. (Block S104)

The first mobile terminal transmits a file that needs to be shared to the second mobile terminal. (Block S105)

The connection with the second mobile terminal is disconnected after the first mobile terminal finishes transmission. (Block S106)

Specifically, before the above steps, when the first mobile terminal establishes a connection with the second mobile terminal for the first time, the first mobile terminal may assign a string of SSID sequence for the second mobile terminal, for identifying the second mobile terminal, and the SSID sequence is stored in the first mobile terminal. At the same time, the first mobile terminal may also send this string of SSID sequence to the second mobile terminal, notify the second mobile terminal that the SSID is used for file sharing, and notify the second mobile terminal to store the SSID sequence. The SSID sequence may be an SSID sequence formed by several SSIDs manually input by the user of the first mobile terminal, and may also be an SSID sequence formed by several SSIDs randomly generated by the first mobile terminal.

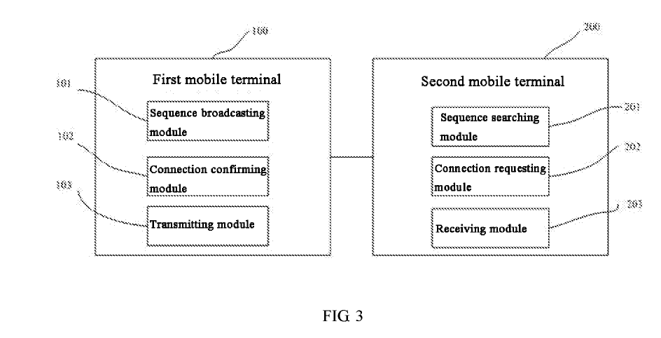

The present invention further provides a system for sharing a file between mobile terminals, referring to FIG. 3, and the system includes: a first mobile terminal 100 and a second mobile terminal 200. The first mobile terminal 100 is configured to share a file, and the second mobile terminal 200 is configured to receive the shared file.

Specifically, the first mobile terminal 100 may include: a sequence broadcasting module 101, a connection confirming module 102, and a transmitting module 103.

The sequence broadcasting module 101 is configured to broadcast the SSID sequence circularly at a time interval T1.

The connection confirming module 102 is configured to confirm a connection request sent to the first mobile terminal 100, and establish a connection with the second mobile terminal 200 sending the request.

The transmitting module 103 is configured to send a file that needs to be shared to the connected second mobile terminal 200.

Further, the second mobile terminal 200 may include: a sequence searching module 201, a connection requesting module 202, and a receiving module 203.

The sequence searching module 201 is configured to search for an SSID sequence stored in the second mobile terminal 200.

The connection requesting module 202 is configured to send a connection request to the first mobile terminal 100 broadcasting the SSID sequence. The receiving module 203 is configured to receive the shared file sent by the connected first mobile terminal 100.

Further, the first mobile terminal 100 may further include:

a storage module, configured to store a database including a mobile terminal establishing a connection with the first mobile terminal 100 through an SSID sequence and the corresponding SSID sequence.

Unit modules of the system for sharing a file between mobile terminals are thus all described in detail in the above method.

In a method and system for sharing a file between mobile terminals provided in the present invention, when a first mobile terminal detects an operation of sharing a file with a second mobile terminal, an SSID sequence corresponding to the second mobile terminal is acquired; the first mobile terminal establishes a connection with the second mobile terminal through broadcasting the SSID sequence, and the first mobile terminal transmits a file that needs to be shared to the second mobile terminal. The first mobile terminal establishes a connection with the second mobile terminal through the SSID sequence, and when the second mobile terminal finds the SSID sequence through searching. In this way, when the first mobile terminal needs to share a file with the second mobile terminal, the first mobile terminal can directly share the file with the second mobile terminal by only one operation step, which greatly improves the operation efficiency of the mobile terminal, and brings convenience to a user. It fundamentally solves the problem of a complicated and inconvenient process for sharing a file between mobile terminals in the prior art, in which multiple operations are required on the mobile terminals.

The system for sharing a file between mobile terminals and the method for sharing a file between mobile terminals belong to the same concept, and any method provided in the embodiments of the method for sharing a file between mobile terminals may be run on the system for sharing a file between mobile terminals. Specific implementation processes may be obtained in detail with reference to the embodiments of the method for sharing a file between mobile terminals.

It should be noted that, for the method for sharing a file between mobile terminals according to the embodiments of the present invention, persons of ordinary skill in the art may understand that all or part of processes of the method for sharing a file between mobile terminals according to the embodiments of the present invention may be implemented by a computer program controlling related hardware. The computer program may be stored in a computer readable storage medium, for example, stored in a memory of a mobile terminal, and executed by at least one processor in the mobile terminal, processes of the embodiments of the above methods may be included during execution. The storage medium may be a magnetic disk, an optical disc, a read-only memory (ROM), a random access memory (RAM), and the like.

For the system for sharing a file between mobile terminals according to the embodiments of the present invention, function modules thereof may be integrated in a processing chip, the modules may also exist physically separately, or two or more modules are integrated in one module. The integrated module may be implemented in a form of hardware or in a form of software function module. When the integrated module is implemented in a form of software function module and is sold or used as a standalone product, the integrated module may be stored in a computer readable storage medium. The storage medium may be, for example, a ROM, a magnetic disk, an optical disc, or the like.

It is understandable that, for a person of ordinary skill in the art, equivalent replacements or changes may be made according to the technical solutions and inventive concepts of the present invention, and all these changes or replacements shall fall within the protection scope of the claims in the present invention.

1. A method for sharing a file between mobile terminals, comprising:
acquiring an SSID sequence corresponding to a second mobile terminal when a first mobile terminal detects an operation of sharing the file with the second mobile terminal;
comparing a size of the file with a set threshold; and when the size of the file exceeds the threshold, storing the file in an intermediate memory space and generating a download link;
broadcasting, by the first mobile terminal, the SSID sequence and establishing a connection with the second mobile terminal;
transmitting, by the first mobile terminal, the download link to the second mobile terminal; and
transmitting, by the first mobile terminal, the file to the second mobile terminal, when the file size is less than or equal to the threshold.

2. The method for sharing a file between mobile terminals according to claim 1, wherein before acquiring the SSID sequence the method further comprises:
enabling WI-FI functions of the first mobile terminal and the second mobile terminal in advance.

3. The method for sharing a file between mobile terminals according to claim 1, wherein the acquiring comprises:
acquiring the file when the first mobile terminal detects the operation of sharing the file with the second mobile terminal;
comparing the second mobile terminal with a pre-established mobile terminal database; and
acquiring an SSID sequence corresponding to the second mobile terminal according to a comparison result.

4. The method for sharing a file between mobile terminals according to claim 3, wherein the mobile terminal database is pre-disposed in the first mobile terminal, and the mobile terminal database comprises a mobile terminal establishing a connection with the first mobile terminal through an SSID sequence and a corresponding SSID sequence.

5. The method for sharing a file between mobile terminals according to claim 3, further comprising:
generating, by the first mobile terminal, the SSID sequence randomly when the second mobile terminal does not exist in the pre-established mobile terminal database, and sending the SSID sequence to the second mobile terminal;
receiving, by the second mobile terminal, the SSID sequence and storing it; and
binding, by the first mobile terminal, the second mobile terminal and the SSID sequence and storing them in the mobile terminal database.

6. The method for sharing a file between mobile terminals according to claim 1, wherein the broadcasting comprises:
broadcasting, by the first mobile terminal, the SSID sequence circularly, a time interval thereof being T1;
sending, by the second mobile terminal, a connection request to the first mobile terminal when the SSID sequence is found through searching; and
stopping the broadcasting, by the first mobile terminal, of the SSID sequence and establishing a connection with the second mobile terminal.

7. The method for sharing a file between mobile terminals according to claim 6, wherein the sending comprises:
comparing, by the second mobile terminal, the SSID sequence with an SSID sequence stored in the second mobile terminal when the SSID sequence is found through searching; and
sending, by the second mobile terminal, the connection request to the first mobile terminal when the SSID sequence found through searching is identical to the SSID sequence stored by the second mobile terminal.

8. The method for sharing a file between mobile terminals according to claim 1, wherein after the transmitting the method further comprises:
disconnecting the connection with the second mobile terminal after the first mobile terminal finishes transmitting the file.

9. A method for sharing a file between mobile terminals, comprising:
acquiring an SSID sequence corresponding to a second mobile terminal when a first mobile terminal detects an operation of sharing the file with the second mobile terminal;
broadcasting, by the first mobile terminal, the SSID sequence and establishing a connection with the second mobile terminal; and
transmitting, by the first mobile terminal, the file to the second mobile terminal.

10. The method for sharing a file between mobile terminals according to claim 9, wherein before the acquiring the method further comprises:
enabling WI-FI functions of the first mobile terminal and the second mobile terminal in advance.

11. The method for sharing a file between mobile terminals according to claim 9, wherein the acquiring comprises:
acquiring the file when the first mobile terminal detects the operation of sharing the file with the second mobile terminal;
comparing the second mobile terminal with a pre-established mobile terminal database; and
acquiring an SSID sequence corresponding to the second mobile terminal according to a comparison result.

12. The method for sharing a file between mobile terminals according to claim 11, wherein the mobile terminal database is pre-disposed in the first mobile terminal, and the mobile terminal database comprises a mobile terminal establishing a connection with the first mobile terminal through an SSID sequence and a corresponding SSID sequence.

13. The method for sharing a file between mobile terminals according to claim 11, further comprising:
generating, by the first mobile terminal, the SSID sequence randomly when the second mobile terminal does not exist in the pre-established mobile terminal database, and sending the SSID sequence to the second mobile terminal;
receiving, by the second mobile terminal, the SSID sequence and storing it; and
binding, by the first mobile terminal, the second mobile terminal and the SSID sequence and storing them in the mobile terminal database.

14. The method for sharing a file between mobile terminals according to claim 9, wherein the broadcasting comprises:
broadcasting, by the first mobile terminal, the SSID sequence circularly, a time interval thereof being T1;
sending, by the second mobile terminal, a connection request to the first mobile terminal when the SSID sequence is found through searching; and
stopping the broadcasting, by the first mobile terminal, of the SSID sequence and establishing a connection with the second mobile terminal.

15. The method for sharing a file between mobile terminals according to claim 14, wherein the sending comprises:
comparing, by the second mobile terminal, the SSID sequence with an SSID sequence stored in the second mobile terminal when the SSID sequence is found through searching; and
sending, by the second mobile terminal, the connection request to the first mobile terminal when the SSID sequence found through searching is identical to the SSID sequence stored by the second mobile terminal.

16. The method for sharing a file between mobile terminals according to claim 9, wherein after the transmitting the method further comprises:
disconnecting the connection with the second mobile terminal after the first mobile terminal finishes transmitting the file.

17. A system for sharing a file between mobile terminals, comprising: a first mobile terminal and a second mobile terminal, wherein
the first mobile terminal comprises one or more modules configured to:
broadcast a SSID sequence circularly at a time interval T1;
confirm a connection request sent to the first mobile terminal, and establish a connection with the second mobile terminal sending the request;
send the file to the connected second mobile terminal;
and wherein the second mobile terminal comprises one or more modules configured to:
search for the SSID sequence stored in the second mobile terminal;
send a connection request to the first mobile terminal broadcasting the SSID sequence; and
receive the file sent by the connected first mobile terminal.

18. The system for sharing a file between mobile terminals according to claim 17, wherein the one or more modules of the first mobile terminal are further configured to:
store a database comprising a mobile terminal establishing a connection with the first mobile terminal through an SSID sequence and a corresponding SSID sequence.

19. The method of claim 1, wherein the intermediate memory space comprises a cloud server.

20. The system of claim 17, wherein the one or more modules of the first mobile terminal are further configured to:
disconnect the connection with the second mobile terminal after the first mobile terminal finishes sending the file.
